(19) United States
(12) Patent Application Publication
(10) Pub. No.: US 2026/0195530 A1
(43) Pub. Date: Jul. 9, 2026

(54) FACT-BASED VALIDATION PIPELINES FOR ENTERPRISE DOCUMENTATION

(71) Applicant: SAP SE, Walldorf (DE)

(72) Inventor: Vladimir WASIUTINSKI, Dresden (DE)

(21) Appl. No.: 19/014,650

(22) Filed: Jan. 9, 2025

(51) Int. Cl. G06F 40/226; G06F 40/253

(52) U.S. Cl. CPC G06F 40/226; G06F 40/253

(57) ABSTRACT

An enterprise documentation data store contains records representing a plurality of documents in an enterprise corpus (including a document identifier). A semantic search pipeline data store contains records representing semantic search pipelines (including a pipeline identifier and at least one tuning parameter). A GenAI validation platform can then identify at least one document in the enterprise documentation data store to be validated. The GenAI validation platform accesses information in the semantic search pipeline data store associated with a semantic search pipeline. It automatically performs a fact-based validation of the identified document using the semantic search pipeline to generate a validation report suggesting changes to the identified document. Embodiments may also arrange to automatically implement the suggested changes.

### BACKGROUND

The quality of product and software documentation created by an enterprise may be very important to customers. This is getting even more important in the era of Generative Artificial Intelligence (“GenAI”), because GenAI applications (e.g., question answering assistants) are being trained or grounded on the documentation and completely rely on their quality. The current approaches for ensuring quality of the documentation include guidelines for document creators and introducing checks for document structure, proper tone, phrasing, etc. However, these approaches are limited and they usually check separate documentation pieces based on certain rules without checking the documents against exposed documentation. This can lead to inconsistencies in documentation, bad customer experience, and additional manual efforts for documentation creators and user assistants to address these issues.

The traditional documentation approaches have been based on the rules and templates that involve a lot of work for human user assistants. With the rise of GenAI, these approaches have been enhanced by natural language prompts which enable easier validation and/or generation of text. The types of validation are limited by the defined rules for compliance, tone and phrasing, as well as the provided context.

GenAI can utilize a Large Language Model (“LLM”) to achieve general-purpose language generation and other natural language processing processes. Based on language models, LLMs acquire these abilities by learning statistical relationships from substantial amounts of text (e.g., from a knowledge base) during a training process. LLMs can take an input text or prompt and predict future tokens or words using artificial neural networks. In some cases, an LLM may answer user queries in various contexts by cross-referencing knowledge sources. Some drawbacks of the basic LLM approach include presenting false information (or “hallucinations”) and responses with out-of-date or generic information.

To address these and other issues, Retrieval-Augmented Generation (“RAG”) optimizes the output of a LLM so that it references an authoritative knowledge base outside of the original training data sources. RAG can extend LLM capabilities to specific domains or an organization's internal knowledge base without retraining the model. For example, FIG. 1 is a high-level system 100 RAG architecture that includes a LLM 110, a vector search 120, and a vector data store 130. FIG. 2 is a basic RAG method that begins with receiving a user query at S210. In response to the user query, the LLM 110 interprets the query using embedding at S220. A vector search 120 is performed using information in the vector data store 130 at S230. The vector data store 130 might be populated with, for example, information gathered from a knowledge base of enterprise documents (e.g., emails, memos, reports, etc.). The vector search 120 returns relevant context information specific to that enterprise which is used by the LLM 110 to generate an appropriate response to the user query at S240. In this way, RAG redirects the LLM 110 to retrieve relevant context information from authoritative, pre-determined knowledge sources giving an organization control over the text output that is generated. In this way, RAG may provide a cost-effective AI implementation (because the LLM 110 doesn't need to be retrained with the new data), and more current information can be included without retraining.

RAG has been very successful at information retrieval and question answering. However, it can be difficult, time consuming, and costly to efficiently review the documentation—especially when there is a substantial amount of enterprise information and/or a large number of data sources to be considered. As a result, various parameters of a RAG system may be adjusted or “tuned” looking to improve results. For example, the adjustments might seek to improve the cleanliness of data from the data sources provided as context to the LLM for answers. Similarly, the embedding model and the chunking algorithm might be adjusted, the retrieval system (including the vector database) might be fine-tuned, the LLM model and prompt generator might be changed, etc. The set of tuning adjustments may represent an RAG “pipeline” that is customized for a particular domain (e.g., product documentation validation).

It would be desirable to provide validation of enterprise documentation in a secure, automatic, and efficient manner.

### SUMMARY

According to some embodiments, methods and systems may include an enterprise documentation data store that contains records representing a plurality of documents in an enterprise corpus (including a document identifier). A semantic search pipeline data store contains records representing semantic search pipelines (including a pipeline identifier and at least one tuning parameter). A GenAI validation platform can then identify at least one document in the enterprise documentation data store to be validated. The GenAI validation platform accesses information in the semantic search pipeline data store associated with a semantic search pipeline. It automatically performs a fact-based validation of the identified document using the semantic search pipeline to generate a validation report suggesting changes to the identified document. Embodiments may also arrange to automatically implement the suggested changes.

Some embodiments comprise: means for identifying, by a computer processor of a GenAI validation platform, at least one document in an enterprise documentation data store to be validated, wherein the GenAI validation platform is associated with at least one LLM and the enterprise documentation data store contains electronic records that represent a plurality of documents in an enterprise corpus, each record including a document identifier; means for accessing information in a RAG pipeline data store associated with a first RAG pipeline, wherein the RAG pipeline data store contains electronic records that represent RAG pipelines, each record including a pipeline identifier and at least one tuning parameter; means for accessing information in the RAG pipeline data store associated with a second RAG pipeline; means for automatically performing a first fact-based validation of the identified document using the first RAG pipeline; means for automatically performing a second fact-based validation of the identified document using the second RAG pipeline; means for merging results of the first and second fact-based validations to generate a validation report suggesting changes to the identified document; and means for arranging to automatically implement suggested changes in the validation report.

Some technical advantages of some embodiments disclosed herein are improved systems and methods to provide validation of enterprise documentation in a secure, automatic, and efficient manner.

### BRIEF DESCRIPTION OF THE DRAWINGS

FIG. 1 is a high-level system RAG architecture.

FIG. 2 is a basic RAG method.

FIG. 3 is a more detailed system RAG architecture.

FIG. 4A is a high-level system architecture in accordance with some embodiments.

FIG. 4B is a more general system architecture in accordance with some embodiments.

FIG. 5 is an enterprise documentation validation method according to some embodiments.

FIG. 6 is a validation workflow in accordance with some embodiments.

FIG. 7 is a documentation check workflow according to some embodiments.

FIG. 8A is an example of serial execution in accordance with some embodiments.

FIG. 8B is an example of parallel execution according to some embodiments.

FIG. 9 is a workflow for documentation validation checks in accordance with some embodiments.

FIG. 10 is an apparatus or platform according to some embodiments.

FIG. 11 is a portion of a documentation validation database in accordance with some embodiments.

FIG. 12 illustrates a tablet computer documentation validation display according to some embodiments.

FIG. 13 is an operator or administrator documentation validation display in accordance with some embodiments.

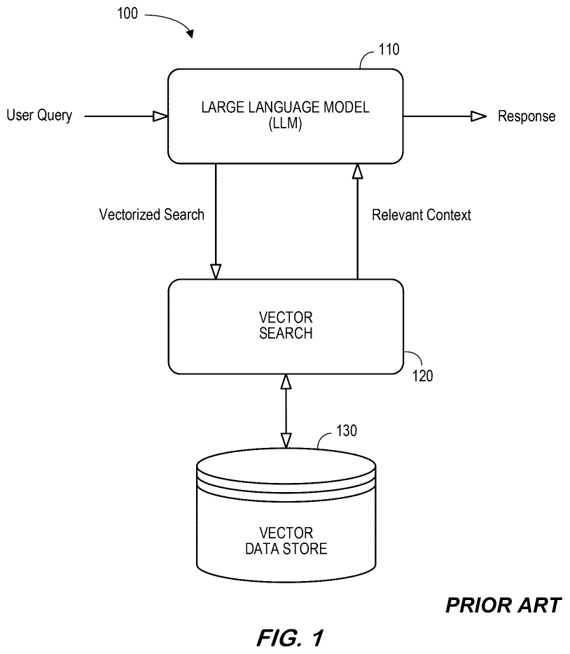

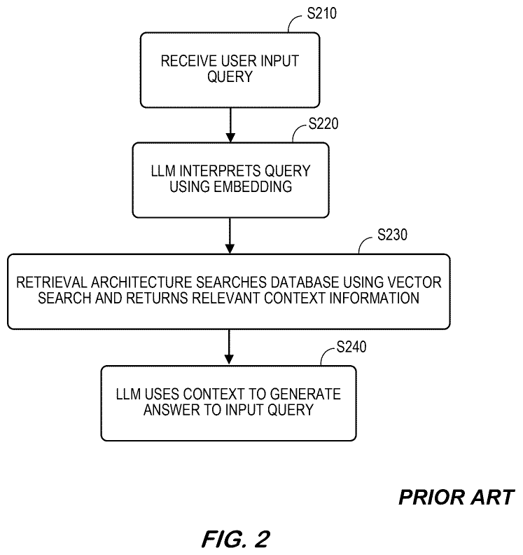

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

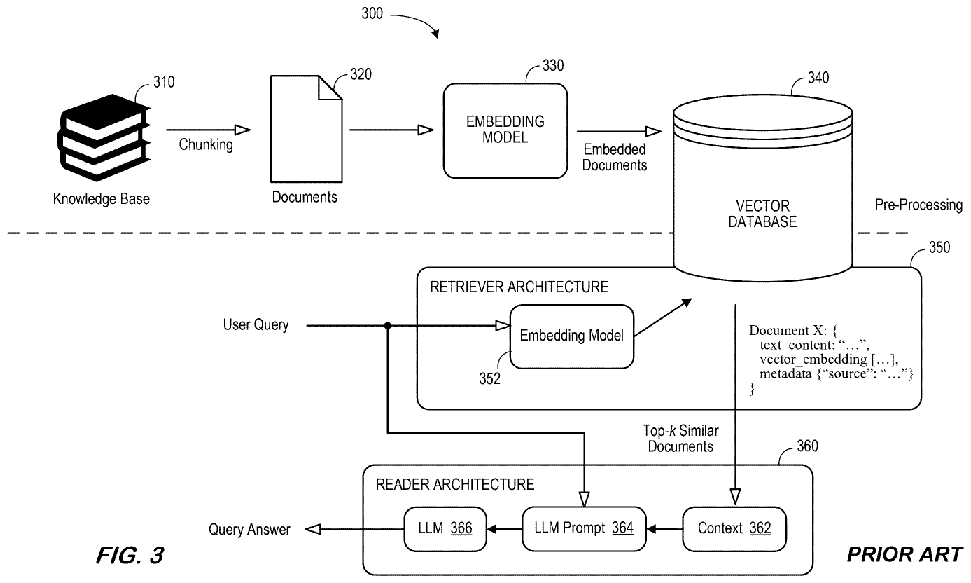

Some embodiments described herein utilize RAG. Note, however, that embodiments may use other types of validation (e.g., semantic search). RAG is only one method to search for facts based on which validation is being done. Given a user question, RAG attempts to find the most relevant snippets from a knowledge base to answer that question. FIG. 3 is a more detailed system 300 RAG architecture. In pre-processing, documents 320 from a knowledge base 310 are provided to an embedding model 330. This process may involve “chunking” the information. Note that the system 300 may be associated with a substantial volume of unstructured data (e.g., a corpus with many documents, a library of millions of pictures, thousands of hours of video, etc.) and structured data (e.g., databases with service descriptions, APIs, etc.). Chunking divides data up into chunks prior to storage, so that each one can be inspected for relevance to an input query during a search. The system 300 may include some overlap in these chunks, to avoid information being split between chunk boundaries (and thus lost). The size and format of these chunks can vary from application to application.

To provide answers in a useful timeframe, RAG needs to rapidly search a database of information on which it was not trained and return relevant pieces of context information. The system 300 may first map data to a numerical vector via “vector embedding.” As used herein, the phrase “vector embedding” may refer to the process of representing an arbitrary piece of unstructured data as an n-dimensional array of numbers. The numbers are not inherently meaningful or interpretable, but they provide a way of comparing two pieces of unstructured data by mapping them to a point in n-dimensional space. Similar pieces of data will sit close to one another in the vector space, and dissimilar pieces of data will be further away.

The embedding model 330 can then store information about embedded documents in a vector database 340. The vector database 340 might include, for each document, text content, vector values, metadata (e.g., a document title, enterprise identifier, date, and a source of the information), etc. As used herein, the phrase “vector database” may refer to a data store that is designed and optimized to handle vector data (as opposed to a tabular data stored by traditional relational databases). They provide efficient storage, indexing, and querying mechanisms (optimized for high-dimensional and variable-length vectors) and allow for flexible data storage and retrieval.

The retriever architecture 350 acts as an internal search engine—given a user query, it returns relevant snippets that originated in the knowledge base 310. The snippets are then fed to a reader architecture 360 to help it generate a response. Initially, the retriever architecture 350 receives a user query or question. The retriever architecture 350 includes an embedding model 352 that processes the user query. The embedded user query can then be used to access information from the vector database 340. For example, the system 300 might locate the top-k closest documents to the embedded user query based on semantic similarity. That is, the system wants to find the k documents that have the closest meaning by picking the k closest vectors. There are many ways of measuring the distance between vectors, such as Euclidean distance, Cosine distance, a dot product projection, Manhattan distance, any other state-of-the-art similarity search technique, etc.

This information is provided as context 362 in the reader architecture 360 that processes and aggregates document contents for use in an LLM prompt 364. Such a process may involve prompt compression and/or reranking techniques. As used herein, the term “reranking” may refer to retrieving more documents than needed and then reranking the results before selecting the top k. The LLM prompt 364 is then created based on the original user query and the additional relevant context 362. Finally, an LLM 366 converts the LLM prompt 364 into an RAG query answer or response.

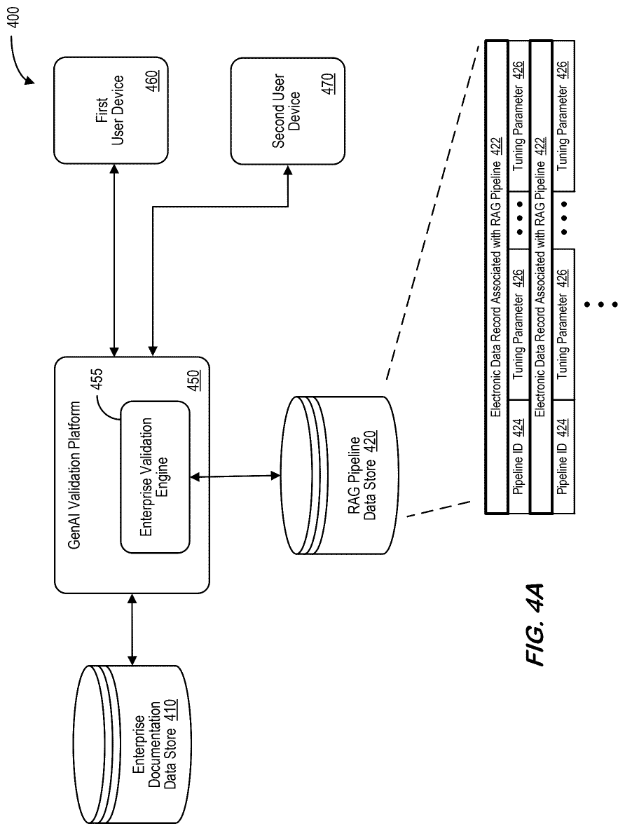

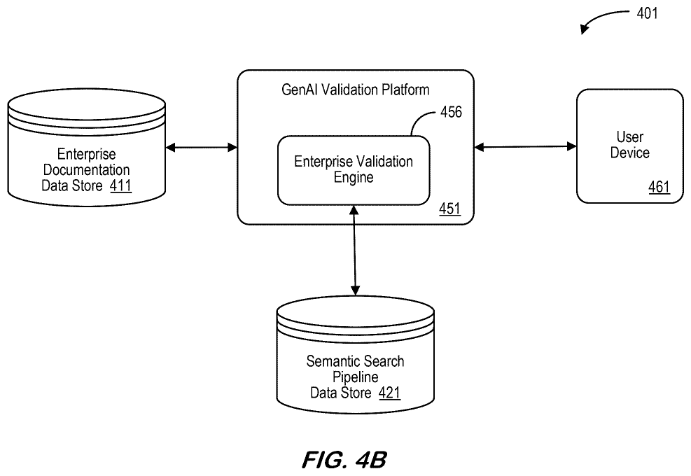

While the system 300 may help optimize an output of a LLM by referencing an authoritative knowledge base outside of the training data sources before generating a response, it would be helpful it could also efficiently and accurately provide enterprise documentation validation for the system 300. FIG. 4A is a high-level block diagram of one example of a system 400 architecture according to some embodiments. In particular, an enterprise documentation data store 410 may contain software manuals, product descriptions, troubleshooting guidance, etc. A RAG pipeline data store 420 may contain electronic data records associated with RAG pipelines 422. Each RAG pipeline might, for example, be associated with a pipeline identifier 424, tuning parameters 426, etc. The system 400 may include a GenAI validation platform 450 with an enterprise validation engine 455 that can provide validation capabilities via interactions with first and second user devices 460, 470. According to some embodiments, the enterprise validation engine 455 utilizes multiple RAG pipelines.

As used herein, devices, including those associated with the system 400 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The enterprise validation engine 455 may store information into and/or retrieve information from various data stores (e.g., the enterprise documentation data store 410 and RAG pipeline data store 420), which may be locally stored or reside remote from the enterprise validation engine 455. Although a single GenAI validation platform 450 and enterprise validation engine 455 are shown in FIG. 4A, any number of such devices may be included. Moreover, various devices described herein might be combined according to embodiments of the present invention. For example, in some embodiments, the RAG pipeline data store 420 and GenAI validation platform 450 might comprise a single apparatus. The system 400 functions may be performed by a constellation of networked apparatuses, such as in a distributed processing or cloud-based architecture. In some cases, the GenAI validation platform 450 may process information associated with a number of different enterprises, tenants, or customers.

The system 400 may be accessed via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the elements connect with an enterprise computing environment infrastructure) and/or provide or receive automatically generated recommendations, alerts, summaries, or results associated with the system 400.

FIG. 4B is a more general system 401 architecture in accordance with some embodiments. As before, an enterprise documentation data store 411 may contain software manuals, product descriptions, troubleshooting guidance, etc. A sematic search pipeline data store 420 may contain electronic data records associated with semantic search pipelines 422. As used herein, the phrase “semantic search” may refer to a search with meaning. A semantic search may improve search accuracy by understanding intent and the contextual meaning of terms as they appear in a searchable dataspace to generate more relevant results. Each semantic search pipeline might, for example, be associated with a pipeline identifier, tuning parameters, etc. The system 401 may include a GenAI validation platform 451 with an enterprise validation engine 456 that can provide validation capabilities via interactions with a user device 461. According to some embodiments, the enterprise validation engine 456 utilizes multiple semantic search pipelines. For example, a semantic search can be enhanced by further search methods (e.g., combined with a keyword search) to improve results (e.g., a hybrid search).

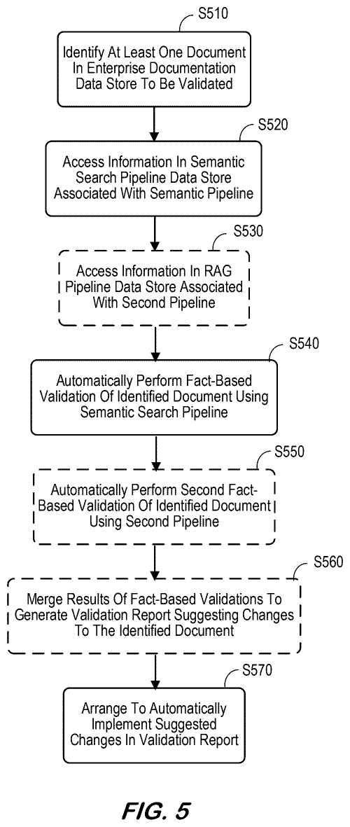

FIG. 5 is an enterprise documentation validation method that might be performed by some or all of the elements of the systems 400, 401 described with respect to FIG. 4A or 4B. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S510, a computer processor of a GenAI validation platform may identify at least one document in an enterprise documentation data store that will be validated. The GenAI validation platform is associated with at least one LLM and the enterprise documentation data store contains electronic records that represent a plurality of documents in an enterprise corpus (and each record may include a document identifier). The identification of the document to be validated may, in some embodiments, involve receiving validation scope information from a user.

At S520, the system accesses information in a semantic search pipeline data store associated with a semantic search pipeline. The semantic search pipeline data store may, for example, contain electronic records that represent RAG pipelines, (with each record including a pipeline identifier and at least one tuning parameter). In some embodiments, each RAG pipeline might be associated with a document ingestion tuning parameter, a chunk tuning parameter, an embed tuning parameter, a similarity search tuning parameter, a context tuning parameter, etc. Optionally, at S530 the system accesses information in the RAG pipeline data store associated with another pipeline (as illustrated by a dashed line in FIG. 5).

The system can then automatically perform a fact-based validation of the identified document using the semantic search pipeline at S540. As used herein, the term “automatically” may refer to an action that requires little or no human intervention. Optionally, at S550 the system can automatically perform another fact-based validation of the identified document. The GenAI validation platform might, for example, automatically perform the first and second fact-based validations in connection with new document creation and/or existing document maintenance. Note that at least one of the first and second fact-based validations could be associated with validation of documentation of one product, executing checks of a single version,) executing checks across multiple documents for the enterprise, etc.

At S560, results of the first and second fact-based validations may optionally be merged to generate a validation report suggesting changes to the identified document. In can then be arranged to automatically implement suggested changes in the validation report at S570. In some embodiments, the implementation may involve manual review and approval by a documentation expert.

In this way, embodiments provide enhanced fact-based validation of product documentation by comparing it with the whole exposed documentation corpus under involvement of GenAI and semantic search (e.g., RAG). Moreover, it may benefit from the fact that the GenAI cases already produce the appropriate knowledge bases based on product documentation (e.g., in RAG approaches) to provide the suitable context to GenAI prompts. Embodiments may reuse these knowledge bases (which might be vector stores, knowledge graphs, or other types of storage) to run additional checks on documentation content with different validation criteria. To implement that, embodiments may run several types of checks for each document (using for each check a separate RAG pipeline with adapted prompts and retrieval mechanisms). The RAG adaptations may consider the scope of checks, the metadata of documents, preferences of the users, monitoring data and document types to define the RAG pipeline parameters (e.g., suitable prompts, filters for documents, number of retrieved documents, etc.). The results of the validation can then be reviewed by human experts and/or automatically implemented.

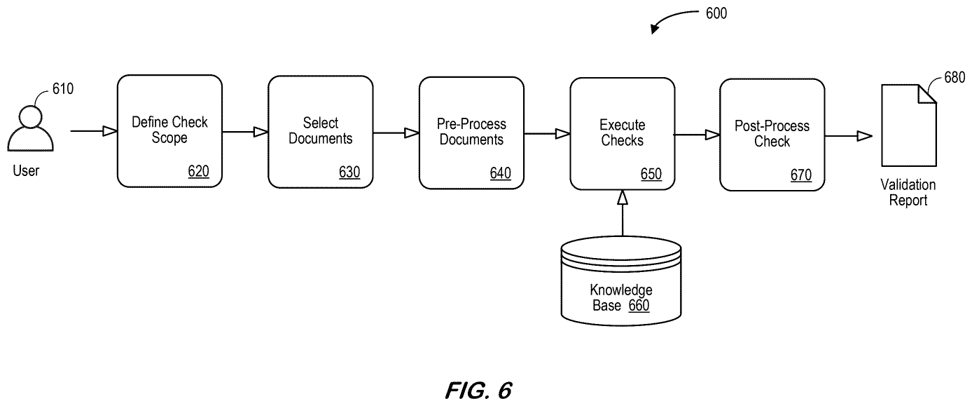

FIG. 6 is a validation workflow 600 in accordance with some embodiments. Initially, a user 610 may define an enterprise documentation check scope 620. The scope may include, for example, a validation use case (e.g., new document, update, cross-validation), a product version, targeted users (e.g., developers, end users, product managers), etc. The check scope might be set by the user 610 or automatically defined. The workflow 600 then selects documents 630 to be validated. Depending on the check scope, validation might be performed, for example, on a single document (e.g., a newly created document), all documents for one product, the whole enterprise corpus, etc.

The workflow 600 can then pre-process the selected documents 640. This might include, for example, subdividing the document into suitable chunks, removing unnecessary content, enriching information with metadata, etc. The system then executes documentation validation checks 650 in connection with a knowledge base 660. This might be done, for example, by running multiple validation check pipelines for each type of check and document chunk.

The knowledge base 660 may include the documentation indexed in a vector store or another search engine, enhanced with the metadata describing documentation version, creator, timeline, scope, etc. It can be enhanced by knowledge graphs describing the semantic models of the company domains, terms/glossaries, or monitoring statistics (e.g., frequency of usage of documentation source, feedback from users). This data and metadata can be used to parameterize the validation checks.

The workflow 600 then post-processes the validation check results 670 (e.g., by summarizing checks, combining chunks and check results into one document, etc.) and using the multiple validation check results to create and output a validation report 680. The validation report 680 might, for example, validate a newly created document, validate the documentation of one product, check across documents of the same version, check across different documents, etc.

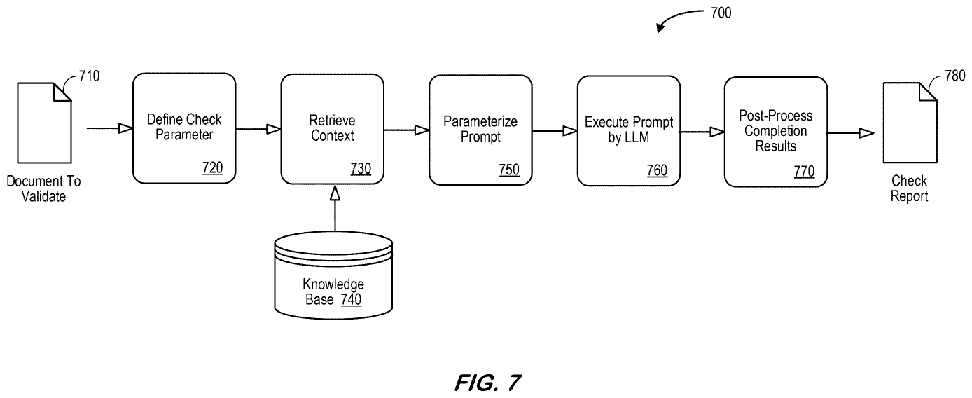

FIG. 7 is a documentation check workflow 700 according to some embodiments. Initially, a document to validate 710 is identified (either by a user or an automatic process). The workflow 700 then defines validation check parameters 720 and retrieves the appropriate context 730 in connection with a knowledge base 740. This might be done, for example, by running multiple validation check pipelines for each type of check and document chunk. The workflow 700 then parameterizes a prompt 750 and executes the prompt with a LLM 760.

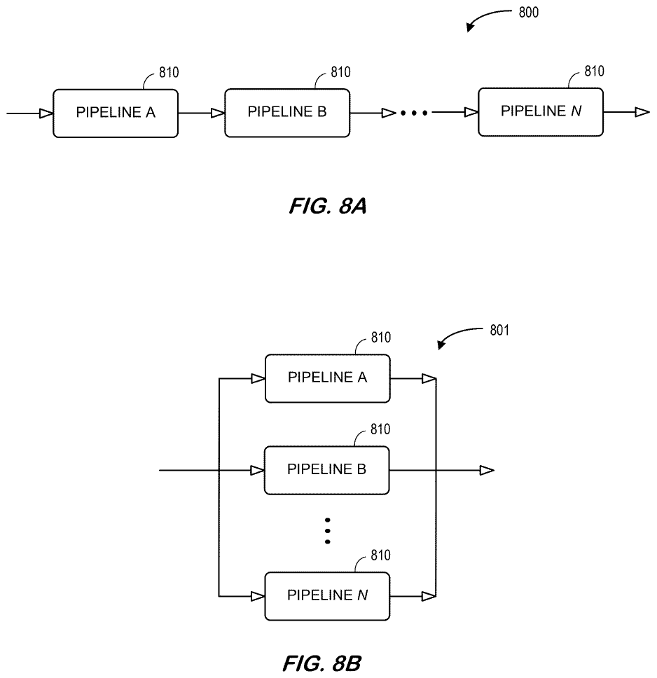

Note that this might involve executing check pipelines in a sequential or parallel way. For example, FIG. 8A is an example 800 of serial execution in accordance with some embodiments. In this case, each pipeline 810 is executed, one after the other, with the results being merged or appended along the way (“pipeline A,” followed by “pipeline B,” etc. until the last “pipeline N” is reached). FIG. 8B is an example 801 of parallel execution according to some embodiments. In this case, the pipelines 810 are executed simultaneously with the various results being merged after execution (“pipeline A,” “pipeline B,” “pipeline N” are executed at the same time). Note that each validation check pipeline 810 may have the same RAG-based structure but differs in the parameters which are defined before execution.

Referring again to FIG. 7, the workflow 700 then post-processes the validation check results 770 (e.g., by summarizing checks, combining chunks and check results into one document, etc.) and using the multiple validation check results to create and output a validation check report 780 that suggests documentation improvements.

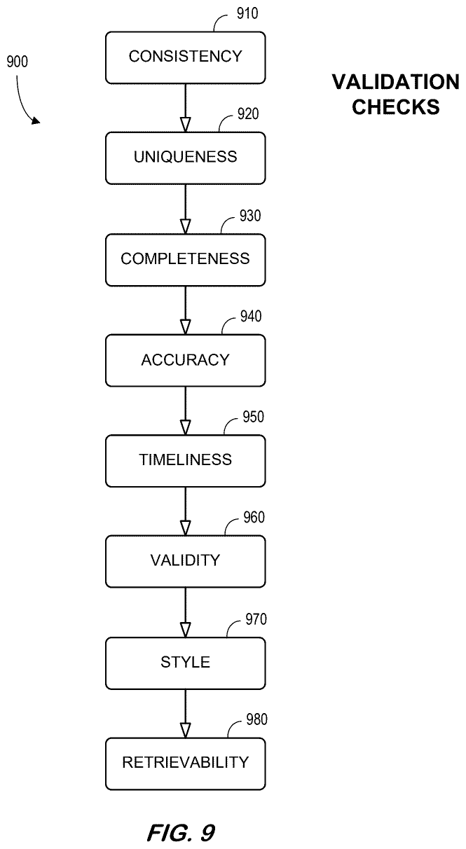

FIG. 9 is a workflow 900 for documentation validation checks in accordance with some embodiments. The workflow 900 shows some examples of various validation checks and how the retrieval parameters might be defined. Note that for each kind of validation check, a separate LLM prompt may be created and parameterized. At 910, consistency may determine if the document contradicts other documents and data sources. The retrieval scope could be, for example, set to one product version.

At 920, uniqueness may determine if a document contains duplications within the scope (e.g., product version). This may involve setting the retrieval scope (e.g., to one product version). At 930, completeness may determine if there are missing facts (e.g., as compared to the previous version or the history of changes). The retrieval scope might be set to a product version, the previous product versions (e.g., to decide if something has been removed), and the change history (e.g., from release logs) to determine the latest changes. At 940, accuracy may determine if the document accurately represents reality. Here, the retrieval scope might be set to the product version and release logs.

At 950, timeliness may determine if the document is too old or stale to be valuable. The retrieval scope is set to the product version and previous versions, and release logs. At 960, validity may determine if the document fits from the viewpoint of format, content, and/or structure. The retrieval scope may be set to best examples of documentation formatting which are used to supplement the LLM prompts. At 970, style may determine if a writing style of the document fits with a required scope (providing “one voice” in the documentation). The retrieval scope is set to best examples of documentation styling. Finally, at 980 retrievability may determine if the information can be easily found from this document. Example questions may be generated from the document and run on the knowledge base to determine if the document is being reliably retrieved.

Note that embodiments can be also implemented using agents. In this case GenAI may design validation based not on strict rules but instead letting agents decide what is appropriate depending on enterprise goals. Embodiments might be implemented as an enterprise tool to improve the quality of documentation (and thus also the quality of products). For example, documentation validation could be part of a cross-platform mobile first framework that provides tools, programming languages, and libraries for building applications and sharing code across platforms. As another example, documentation validation might be incorporated as boosters for a cloud platform cockpit in a productive environment. The booster may automate cockpit tasks to help shorten development time for an enterprise.

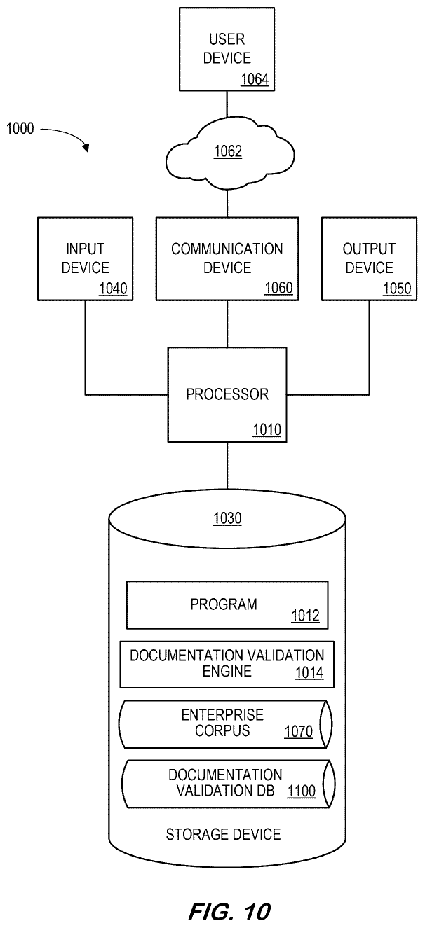

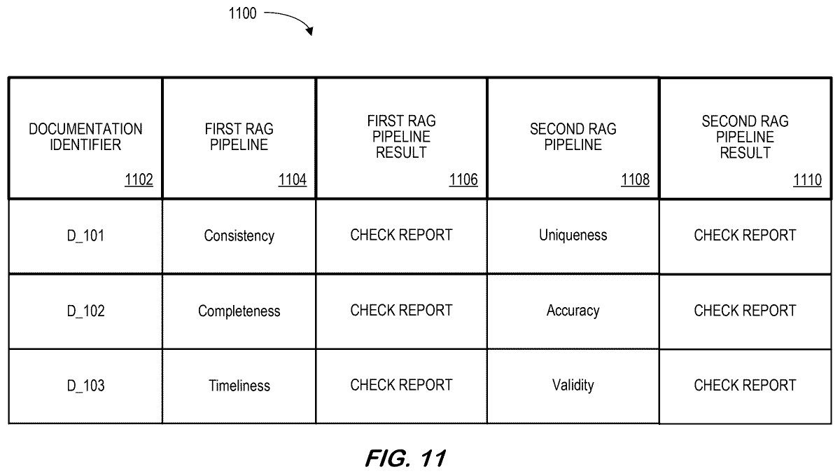

Embodiments described herein may be implemented using any number of different hardware configurations. For example, FIG. 10 is a block diagram of an apparatus or platform 1000 that may be, for example, associated with the systems 400, 401 of FIGS. 4A and 4B (and/or any other system described herein). The platform 1000 comprises a processor 1010, such as one or more commercially available Central Processing Units (“CPUs”) in the form of one-chip microprocessors, coupled to a communication device 1060 configured to communicate via one or more communication networks. The communication device 1060 may be used to communicate, for example, with one or more user devices 1064 via a distributed computer network 1062. The platform 1000 further includes an input device 1040 (e.g., a computer mouse and/or keyboard to input data source information, chunking rules and logic, etc.) and/an output device 1050 (e.g., a computer monitor to render a display, transmit recommendations, evaluations, alerts, reports about validation results, etc.).

The processor 1010 also communicates with a storage device 1030. The storage device 1030 may comprise any appropriate information storage device, including combinations of magnetic storage devices (e.g., a hard disk drive), optical storage devices, mobile telephones, and/or semiconductor memory devices. The storage device 1030 stores a program 1012 and/or documentation validation engine 1014 for controlling the processor 1010. The processor 1010 performs instructions of the programs 1012, 1014, and thereby operates in accordance with any of the embodiments described herein. For example, the processor 1010 may identify at least one document to be validated. The processor 1010 can access information in the RAG pipeline data store associated with a first RAG pipeline and a second RAG pipeline. The processor 1010 automatically performs a first fact-based validation of the identified document using the first RAG pipeline and a second fact-based validation of the identified document using the second RAG pipeline. The results of the first and second fact-based validations are merged by the processor 1010 to generate a validation report suggesting changes to the identified document. Embodiments may also arrange to automatically implement the suggested changes.

The programs 1012, 1014 may be stored in a compressed, uncompiled and/or encrypted format. The programs 1012, 1014 may furthermore include other program elements, such as an operating system, clipboard application, a database management system, and/or device drivers used by the processor 1010 to interface with peripheral devices.

As used herein, information may be “received” by or “transmitted” to, for example: (i) the platform 1000 from another device; or (ii) a software application or module within the platform 1000 from another software application, module, or any other source.

In some embodiments (such as the one shown in FIG. 10), the storage device 1030 further stores an enterprise corpus 1070 and a documentation validation database 1100. An example of a database that may be used in connection with the platform 1000 will now be described in detail with respect to FIG. 11. Note that the database described herein is only one example, and additional and/or different information may be stored therein. Moreover, various databases might be split or combined in accordance with any of the embodiments described herein.

Referring to FIG. 11, a table is shown that represents the documentation validation database 1100 that may be stored at the platform 1000 according to some embodiments. The table may include, for example, entries representing validations that have been executed. The table may also define fields 1102, 1104, 1106, 1108, 1110 for each of the entries. The fields 1102, 1104, 1106, 1108, 1110 may, according to some embodiments, specify: a documentation identifier 1102, a first RAG pipeline 1104, a first RAG pipeline result 1106, a second RAG pipeline 1108, and a second RAG pipeline result 1110. The documentation validation database 1100 may be created and updated, for example, when new enterprise documentation is created, new RAG pipelines are added, fine tune adjustments are made, etc.

The documentation identifier 1102 might be a unique alphanumeric label for an enterprise product description, frequency asked questions, etc. The first RAG pipeline 1104 might contain tuning parameters for a particular type of validation check (e.g., timeliness, accuracy, etc.), and the first RAG pipeline result 1106 might comprise the results of a validation by the first RAG pipeline 1104. Similarly, the second RAG pipeline 1108 might contain tuning parameters for another type of validation check, and the second RAG pipeline result 1110 might comprise the results of a validation by the second RAG pipeline 1108.

In this way, embodiments may provide a platform that introduces more powerful and adaptive documentation validation because it uses facts from knowledge bases and works with the whole documentation corpus of an enterprise.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases and documentation, any of the embodiments described herein could be applied to other types of use cases and documentation.

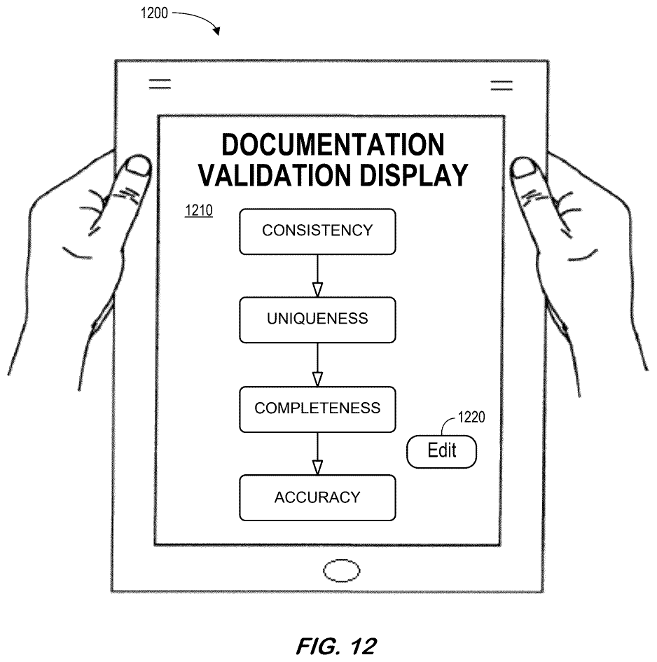

In addition, the displays shown herein are provided only as examples, and any other type of user interface could be implemented. For example, FIG. 12 illustrates a tablet computer 1200 providing a documentation validation user display 1210 according to some embodiments. The display 1210 might be used, for example, to inform the user about tuning parameters and/or pipeline construction. A user may interact with the display 1210, such as via an “Edit” icon 1220 (e.g., to change a documentation validation arrangement, check turning parameter rules or logic, etc.).

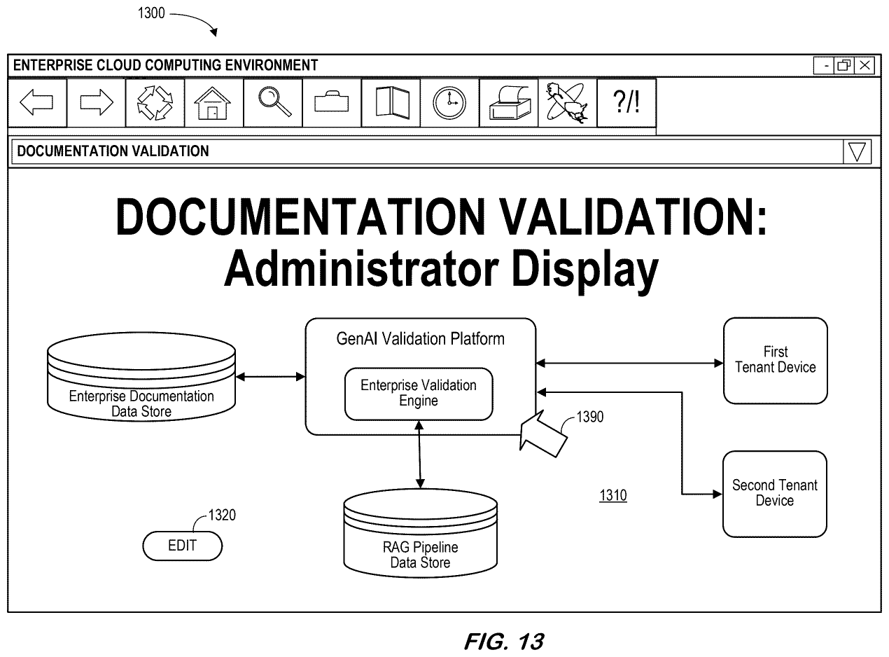

FIG. 13 is an enterprise documentation validation display 1300 in accordance with some embodiments. The display 1300 includes a graphical representation 1310 of a documentation validation framework in accordance with any of the embodiments described herein. Selection of an element on the display 1300 (e.g., via a touchscreen or computer pointer 1390) may result in display of a pop-up window containing more detailed information about that element and/or various options (e.g., to define how a data source interacts with the framework, how users communicate with the framework, etc.). Selection of an “Edit” icon 1320 may also let an operator or administrator adjust the operation of the system (e.g., to change a mapping to a data store, tune chunk size parameters, make changes to embedding models or internal LLMs, add new RAG pipelines and enterprise documentation data stores, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
an enterprise documentation data store containing electronic records that represent a plurality of documents in an enterprise corpus, each record including a document identifier;
a semantic search pipeline data store containing electronic records, each record including a pipeline identifier and at least one tuning parameter; and
a Generative Artificial Intelligence (“GenAI”) validation platform, coupled to the semantic search pipeline data store and being associated with at least one Large Language Model (“LLM”), including:
a computer processor, and
a computer memory storing instructions that, when executed by the computer processor, cause the GenAI validation platform to:
identify at least one document in the enterprise documentation data store to be validated,
access information in the semantic search pipeline data store associated with a semantic search pipeline,
automatically perform a fact-based validation of the identified document using the semantic search pipeline to generate a validation report suggesting changes to the identified document, and
arrange to automatically implement suggested changes in the validation report.

2. The system of claim 1, wherein the semantic search pipeline is a Retrieval-Augmented Generation (“RAG”) pipeline associated with at least one of: (i) a document ingestion tuning parameter, (ii) a chunk tuning parameter, (iii) an embed tuning parameter, (iv) a similarity search tuning parameter, and (v) a context tuning parameter.

3. The system of claim 1, wherein the identification of the at least one document to be validated comprises receiving validation scope information from a user.

4. The system of claim 1, wherein the GenAI validation platform automatically performs first and second fact-based validations in connection with at least one of: (i) document creation, and (ii) document maintenance.

5. The system of claim 4, wherein at least one of the first and second fact-based validations are associated with at least one of: (i) validation of documentation of one product, (ii) executing checks of a single version, and (iii) executing checks across multiple documents.

6. The system of claim 4, wherein at least one of the first and second fact-based validations are associated with consistency to determine if the identified document contradicts other documents.

7. The system of claim 4, wherein at least one of the first and second fact-based validations are associated with uniqueness to determine if the identified document contains duplications within scope.

8. The system of claim 4, wherein at least one of the first and second fact-based validations are associated with completeness to determine if the identified document is missing relevant facts.

9. The system of claim 4, wherein at least one of the first and second fact-based validations are associated with accuracy to determine if the identified document accurately represent reality.

10. The system of claim 4, wherein at least one of the first and second fact-based validations are associated with timeliness to determine if the identified document is too old to be valuable.

11. The system of claim 4, wherein at least one of the first and second fact-based validations are associated with validity to determine if the identified document is appropriate with respect to format, content, and structure.

12. The system of claim 4, wherein at least one of the first and second fact-based validations are associated with style to determine if a writing style of the identified document is appropriate to a required scope.

13. The system of claim 4, wherein at least one of the first and second fact-based validations are associated with retrievability to determine if information in the identified document can be located.

14. The system of claim 4, wherein at least one of the first and second fact-based validations are associated with at least one of: (i) user-defined checks, (ii) natural language prompts, and (iii) other types of validation checks.

15. A computer-implemented method, comprising:
identifying, by a computer processor of a Generative Artificial Intelligence (“GenAI”) validation platform, at least one document in an enterprise documentation data store to be validated, wherein the GenAI validation platform is associated with at least one Large Language Model (“LLM”) and the enterprise documentation data store contains electronic records that represent a plurality of documents in an enterprise corpus, each record including a document identifier;
accessing information in a Retrieval-Augmented Generation (“RAG”) pipeline data store associated with a first RAG pipeline, wherein the RAG pipeline data store contains electronic records that represent RAG pipelines, each record including a pipeline identifier, a document ingestion tuning parameter, a chunk tuning parameter, an embed tuning parameter, a similarity search tuning parameter, and a context tuning parameter;
accessing information in the RAG pipeline data store associated with a second RAG pipeline;
automatically performing a first fact-based validation of the identified document using the first RAG pipeline;
automatically performing a second fact-based validation of the identified document using the second RAG pipeline;
merging results of the first and second fact-based validations to generate a validation report suggesting changes to the identified document; and
arranging to automatically implement suggested changes in the validation report.

16. The method of claim 15, wherein the first and second fact-based validations are associated with all of: (i) consistency, (ii) uniqueness, (iii) completeness, and (iv) accuracy.

17. The method of claim 16, wherein the first and second fact-based validations are associated with timeliness and validity.

18. One or more non-transitory computer-readable media storing computer-executable instructions that, when executed by a computing system, cause the computing system to perform operations, comprising:
identifying, by a computer processor of a Generative Artificial Intelligence (“GenAI”) validation platform, at least one document in an enterprise documentation data store to be validated, wherein the GenAI validation platform is associated with at least one Large Language Model (“LLM”) and the enterprise documentation data store contains electronic records that represent a plurality of documents in an enterprise corpus, each record including a document identifier;
accessing information in a Retrieval-Augmented Generation (“RAG”) pipeline data store associated with a first RAG pipeline, wherein the RAG pipeline data store contains electronic records that represent RAG pipelines, each record including a pipeline identifier and at least one tuning parameter;
accessing information in the RAG pipeline data store associated with a second RAG pipeline;
automatically performing a first fact-based validation of the identified document using the first RAG pipeline;
automatically performing a second fact-based validation of the identified document using the second RAG pipeline;
merging results of the first and second fact-based validations to generate a validation report suggesting changes to the identified document; and
arranging to automatically implement suggested changes in the validation report.

19. The media of claim 18, wherein each RAG pipeline is associated with at least one of: (i) a document ingestion tuning parameter, (ii) a chunk tuning parameter, (iii) an embed tuning parameter, (iv) a similarity search tuning parameter, and (v) a context tuning parameter.

20. The media of claim 18, wherein the identification of the at least one document to be validated comprises receiving validation scope information from a user.
